(19) United States
(12) Patent Application Publication
(10) Pub. No.: US 2023/0079161 A1
(43) Pub. Date: Mar. 16, 2023

(54) COOKWARE LINER

(71) Applicant: Kendra April Richardson, Port Hope (CA)

(72) Inventor: Kendra April Richardson, Port Hope (CA)

(21) Appl. No.: 17/447,706

(22) Filed: Sep. 15, 2021

(51) Int. Cl. A47J 36/16; A47J 36/02

(52) U.S. Cl. CPC A47J 36/16; A47J 36/02

(57) ABSTRACT

A cookware liner that is configured to be disposed within the interior volume of a cooking appliance such as but not limited to a crockpot so as to inhibit food from contacting the interior surfaces of the cookware. The cookware liner of the present invention is manufactured from silicone so as to facilitate multiple re-uses thereof. The present invention includes a body having a bottom and a wall integrally formed to create an interior volume. The body is formed of a size and shape so as to be mateably inserted into the interior volume of the cookware. The body includes a perimeter lip member proximate the upper end thereof. The perimeter lip member extends outward from the wall of the body and is configured to be biased in between the top of the cookware and a lid thereof so as to inhibit the body from collapsing into the cookware.

### FIELD OF THE INVENTION

The present invention relates generally to cookware accessories, more specifically but not by way of limitation, a liner that is operable to be disposed within the interior volume of cookware such as but not limited to a crock pot wherein the liner is reusable, heat resistant and inhibits food from contacting the cookware so as to improve the cleaning process thereof.

### BACKGROUND

Different types of cookware have been around for centuries. Cookware is available in various types and sizes and is typically manufactured to facilitate a particular type of cooking. By way of example but not limitation, conventional pots and pans are utilized on stoves and in ovens to prepare various types of cuisine employing alternate types of techniques. Another type of common cookware is a crockpot. As is known in the art a crockpot is typically an electric type of cooking implement that is designed to be employed for cuisine that is cooked at a lower temperature for a longer period of time. The crockpot offers a convenient method of cooking especially for those that work during the day by allowing food to be placed in the crockpot in the morning and be ready at the end of the day.

One issue with crockpot utilization is the cleaning thereof ensuing the cooking process. Many times food will become baked onto portions of the interior surface of the crockpot resulting in a laborious effort to facilitate the cleaning thereof. While there are plastic liners available for use, these liners are one time use only and then disposed of which results in unnecessary waste. Additionally, current technology does not ensure prevention of potential collapse of a liner once disposed in the interior volume of the crockpot.

Accordingly, there is a need for crockpot liner that is configured to be reusable so as to protect the interior volume of the crockpot from contact with food materials and further provide a structure that inhibits the collapse of the liner during utilization thereof.

### SUMMARY OF THE INVENTION

It is the object of the present invention to provide a cookware liner that is configured to be reusable and heat resistant wherein the cookware liner body of the present invention includes a bottom and a wall integrally formed to create an interior volume.

Another object of the present invention is to provide a crockpot liner that is configured to protect the interior volume of a crockpot during the cooking process wherein the body includes an opening opposite the bottom to provide access to the interior volume of the crockpot liner.

A further object of the present invention is to provide a cookware liner that is configured to be reusable and heat resistant wherein the cookware liner is manufactured from a heat resistant material such as but not limited to silicone.

Still another object of the present invention is to provide a crockpot liner that is configured to protect the interior volume of a crockpot during the cooking process wherein the body further includes a perimeter lip proximate the upper edge thereof.

An additional object of the present invention is to provide a cookware liner that is configured to be reusable and heat resistant wherein the perimeter lip is perpendicular to the wall of the body and extends outward therefrom.

Yet a further object of the present invention is to provide a crockpot liner that is configured to protect the interior volume of a crockpot during the cooking process wherein the body of the present invention is mateably shaped with the interior volume of the crockpot.

Another object of the present invention is to provide a cookware liner that is configured to be reusable and heat resistant wherein the present invention is provided in alternate shapes and sizes so as to be mateably disposed in alternate styles of cookware.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention; and

FIG. 2 is a perspective view of the present invention disposed in a conventional crockpot.

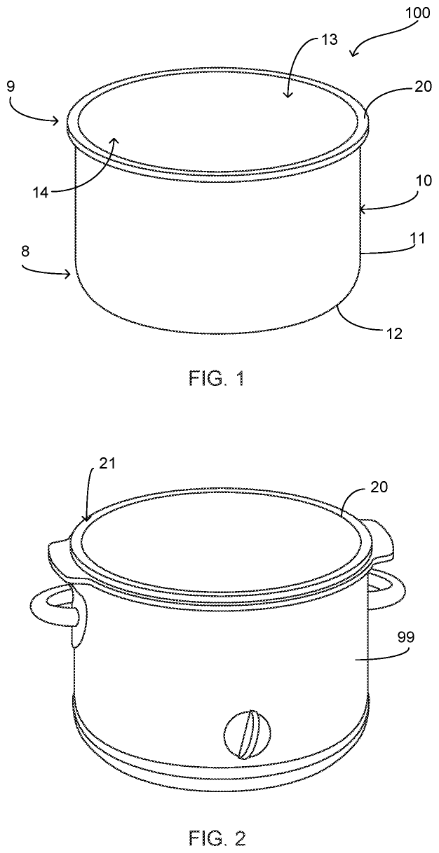

### DETAILED DESCRIPTION

Referring now to the drawings submitted herewith, wherein various elements depicted therein are not necessarily drawn to scale and wherein through the views and figures like elements are referenced with identical reference numerals, there is illustrated a cookware liner 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to Figures submitted as a part hereof, the cookware liner 100 includes a body 10 wherein the body 10 is annular in shape having a lower end 8 and an upper end 9. While the body 10 is illustrated as being annular in shape herein, it should be understood within the scope of the present invention that the size and shape of the body 10 is provided in alternate embodiments so as to mateably be inserted into the interior volume of a crockpot 99. The body 10 is designed so as to be inserted into the interior volume of the crockpot 99(as well as other desired cookware) in order to inhibit food from contacting the interior surfaces of the crockpot 99 during the cooking process. The body 10 is manufactured from a reusable heat resistant material such as but not limited to silicone. Utilization of a material like silicone provides a body 10 that can be utilized during the cooking process and facilitate efficient cleaning thereof subsequent utilization so as to facilitate reuse thereof.

The body 10 includes a bottom 12 and a wall 11 integrally formed so as to define the interior volume 13. While one wall 11 is illustrated herein and is a result of the shape of the illustrated embodiment of the cookware liner 100, it should be understood within the scope of the present invention that the body 10 could be formed with more than one wall to obtain a desired shape. The interior volume 13 is accessible via opening 14 wherein the opening is distally located from the bottom 12 proximate the upper end 9 of the body 10. The opening 14 facilitates the ability to deposit desired items within the interior volume 13 of the body 10 prior to initiation of the cooking process.

The body 10 has formed thereon at the upper end 9 thereof a perimeter lip member 20. The perimeter lip member 20 is integrally formed with the wall 11 of the body 10. The perimeter lip member 20 is structured to extend outward from the wall 11 and be perpendicular thereto. The perimeter lip member 20 engages the crockpot 99 in a manner wherein the top of the crockpot(not illustrated herein) will be superposed the upper surface 21 of the perimeter lip member 20. This inhibits the wall 11 of the body 10 or any portion thereof from collapsing into the crockpot 99 during the cooking process as the perimeter lip member 20 is biased into its position on the top edge of the crockpot 99 via the weight and position of the top of the crockpot. It is contemplated within the scope of the present invention that the perimeter lip member 20 extend outward at least one quarter of an inch in order to accomplish the desired objective discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A cookware liner configured to be releasably disposed within an interior volume of cookware wherein the cookware liner comprises:
a body, said body having at least one wall and a bottom integrally formed to create an interior volume, said body having an upper end and a lower end, said body having an opening proximate said upper end;
a perimeter lip member, said perimeter lip member being integrally formed with said at least one wall, said perimeter lip member being proximate said upper end of said body, said perimeter lip member extending outward from said at least one wall.

2. The cookware liner configured to be releasably disposed within an interior volume of cookware as recited in claim 1, wherein said perimeter lip member is perpendicular to said at least one wall.

3. The cookware liner configured to be releasably disposed within an interior volume of cookware as recited in claim 2, wherein said body is manufactured from silicone.

4. The cookware liner configured to be releasably disposed within an interior volume of cookware as recited in claim 3, wherein said perimeter lip member extends outward from said at least one wall by one quarter of an inch.

5. The cookware liner configured to be releasably disposed within an interior volume of cookware as recited in claim 4, wherein the cookware liner is configured to be disposed within an interior volume of a crockpot.

6. The cookware liner configured to be releasably disposed within an interior volume of cookware as recited in claim 5, wherein the perimeter lip member is operable to be between a lid of the crockpot and an upper edge thereof.
